(19) United States
(12) Patent Application Publication
(10) Pub. No.: US 2004/0122653 A1
(43) Pub. Date: Jun. 24, 2004

(54) Natural language interface semantic object module

(76) Inventors: Peter K.L. Mau, Bellevue, WA (US); Kuansan Wang, Bellevue, WA (US); Alejandro Acero, Bellevue, WA (US)

Correspondence Address: Judson K. Champlin, WESTMAN CHAMPLIN & KELLY, International Centre, 900 South Second Avenue, Suite 1600, Minneapolis, MN, 55402-3319, US

(21) Appl. No.: 10/328,433

(22) Filed: Dec. 23, 2002

(51) Int. Cl. G06F 17/28

(52) U.S. Cl. 704/2

(57) ABSTRACT

A method and apparatus are provided for linking a natural language input to an application. To resolve the natural language input, a semantic object is provided which is indicative of a semantic meaning representation of the natural language input and a semantic result property corresponding to a domain entity of the semantic object. An input to the application can then be provided based upon the semantic object.

### BACKGROUND OF THE INVENTION

The present invention relates to methods and systems for defining and handling user/computer interactions. In particular, the present invention relates to systems that resolve user input into a command or entity.

In typical computer systems, user input has been limited to a rigid set of user responses having a fixed format. For example, with a command line interface, user input must be of a specific form which uniquely identifies a single command and selected arguments from a limited and specific domain of possible arguments. Similarly, with a graphical user interface, only a limited set of options are presented to the user and it is relatively straight forward for a developer to define a user input domain consisting of a limited set of commands or entities for each specific user input in the limited set of user inputs.

By limiting a user to a rigid set of allowed inputs or responses, computer systems have required a significant level of skill from the user or operator. It has traditionally been the responsibility of the user to mentally translate the desired task to be performed into the specific input recognized by the applications running on the computer system. In order to expand the usability of computer systems, there has been an ongoing effort to provide applications with a natural language (NL) interface. The natural language interface extends the functionality of applications beyond their limited input set and opens the computer system to inputs in a natural language format. The natural language interface is responsible for performing a translation from the relatively vague and highly context based realm of natural language into the precise and rigid set of inputs required by a computer application.

Although some forms of natural language interfaces exist, they place a significant burden on the author of an application to develop the semantic definitions required by a natural language interface and link those definitions to specific inputs or actions in the application. Further, modifications to the application may require this link to be revised by the developer.

### SUMMARY OF THE INVENTION

A method and apparatus are provided for linking a natural language input to an application. To resolve the natural language input, a semantic object is provided which is indicative of a semantic meaning representation of the natural language input and a semantic result property corresponding to one or more domain entities of the semantic object. An input to the application can then be provided based upon the semantic object.

### BRIEF DESCRIPTION OF THE DRAWINGS

FIG. 1 is a general block diagram of a personal computing system in which the present invention may be practiced.

FIG. 2 is a block diagram showing the configuration of a natural language interface and application object models in accordance with the invention.

FIG. 3 is a block diagram which illustrates a semantic object in accordance with the invention.

FIG. 4 is a block diagram which illustrates a run time environment which utilizes semantic objects of the invention.

### DETAILED DESCRIPTION OF ILLUSTRATIVE EMBODIMENTS

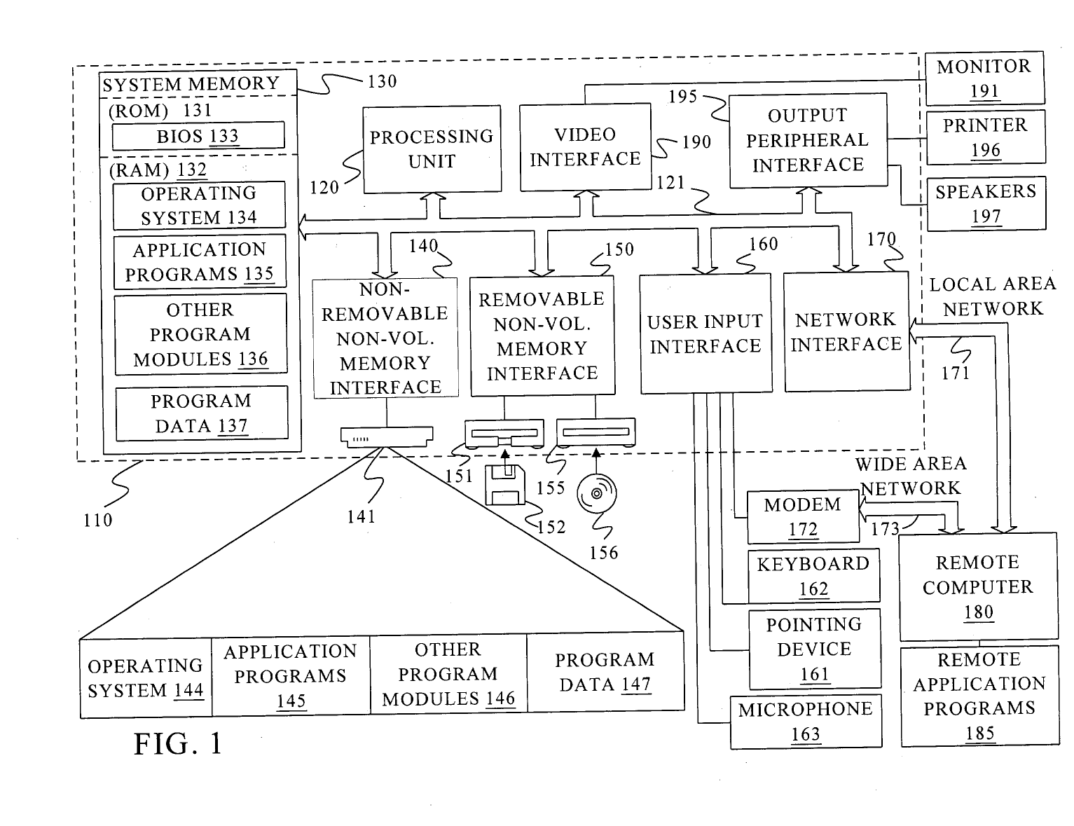

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. For natural user interface applications, a user may further communicate with the computer using speech, handwriting, gaze (eye movement), and other gestures. To facilitate a natural user interface, a computer may include microphones, writing pads, cameras, motion sensors, and other devices for capturing user gestures. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

Typically, application programs 135 have interacted with a user through a command line or a Graphical User Interface (GUI) through user input interface 160. However, in an effort to simplify and expand the use of computer systems, inputs have been developed which are capable of receiving natural language input from the user. In contrast to natural language or speech, a graphical user interface is precise. A well designed graphical user interface usually does not produce ambiguous references or require the underlying application to confirm a particular interpretation of the input received through the interface 160. For example, because the interface is precise, there is typically no requirement that the user be queried further regarding the input, i.e., “Did you click on the ‘ok’ button?” Typically, an object model designed for a graphical user interface is very mechanical and rigid in its implementation.

In contrast to an input from a graphical user interface, a natural language query or command will frequently translate into not just one, but a series of function calls to the input object model. In contrast to the rigid, mechanical limitations of a traditional line input or graphical user interface, natural language is a communication means in which human interlocutors rely on each other's intelligence, often unconsciously, to resolve ambiguities. In fact, natural language is regarded as “natural” exactly because it is not mechanical. Human interlocutors can resolve ambiguities based upon contextual information and cues regarding any number of domains surrounding the utterance. With human interlocutors, the sentence, “Forward the minutes to those in the review meeting on Friday” is a perfectly understandable sentence without any further explanations. However, from the mechanical point of view of a machine, specific details must be specified such as exactly what document and which meeting are being referred to, and exactly to whom the document should be sent.

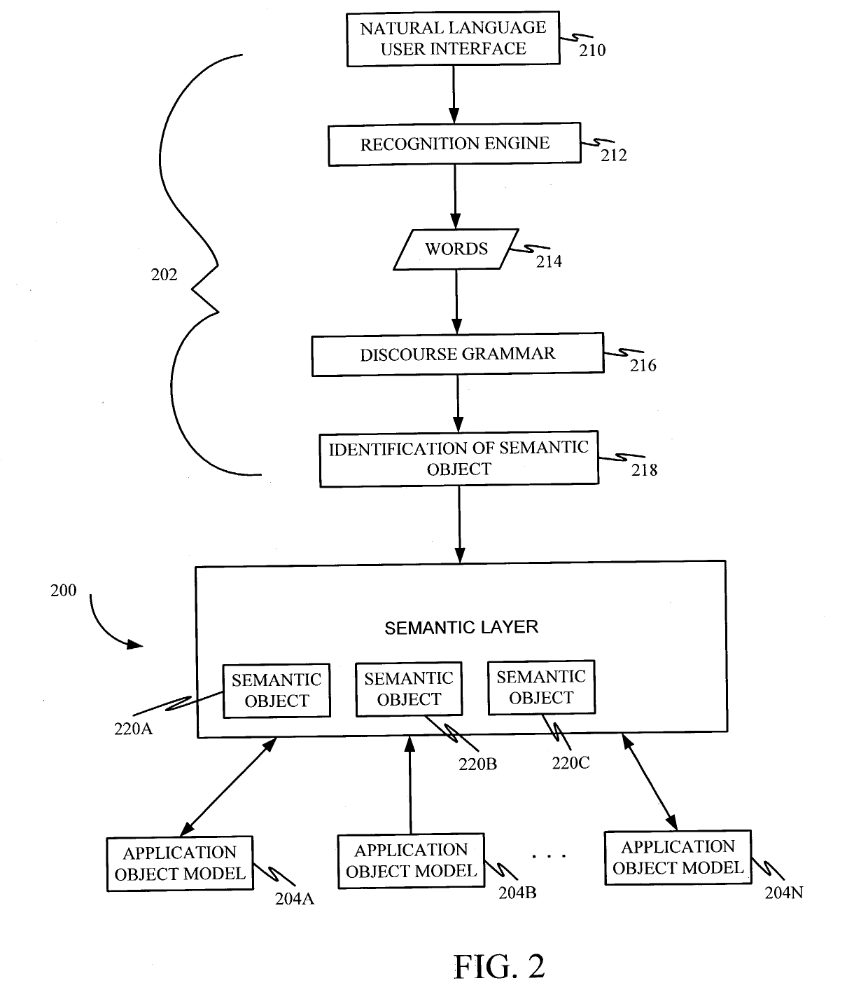

FIG. 2 is a simplified block diagram showing a natural language interface 202 for various applications. As used herein, “semantic” refers to a meaning of natural language expressions. The present invention introduces a semantic layer 200 shown in FIG. 2 between natural language interface 202 and object models of applications 204A, 204B . . . 204N. By introducing the semantic layer 200, application developers can use a single unified approach to enable existing applications to function with a natural language interface and also author new applications which are tailored to the natural language interface. The semantic layer 200 bridges the gap between the domain specific nature of the natural language and the rigid and mechanical input set suitable to drive the object models 204A, 204B . . . 204N. The present invention provides an efficient way to author the semantic schema which identifies semantic objects and their relationships between one another. The present invention is also particularly well suited for linking applications to a shared runtime environment such as that provided by the Common Language Runtime (CLR).

In FIG. 2, the natural language interface 202 is provided for illustrative purposes only and may take other forms. In this specific example, natural language interface 202 includes a natural language user interface 210 which receives the user input, for example through keyboard 162, an optical scanner, microphone input, or other input techniques. A recognition engine 212 is used to identify recognition features 214 in the user input. For example, speech or handwriting recognition techniques can be used. Recognition features for speech are usually words in the spoken language, and recognition features for handwriting usually correspond to strokes in user's handwriting. The recognition features 214 are processed in accordance with discourse grammar 216 and specific semantic objects represented by the user input 214 are identified at 218. For example, at identification block 218 any number of semantic slots can be filled using a recursive hierarchial technique in which the user is prompted for additional information to fill any unfilled slots or clarify any ambiguities.

The semantic layer 200 is composed of any number of semantic objects 220A, 220B, 220C . . . The semantic objects are provided in accordance with the application object models 204A, 204B . . . 204N. Each application object model can provide any number of semantic objects 220A, 220B, 220C . . . and the semantic objects can be shared between object models.

The semantic objects in the semantic layer 200 can be authored, in accordance with one illustrative embodiment of the invention, to easily provide a bridge between an object model of an application and the natural language interface 202. When receiving an input from a natural language interface, eventually the developer must prepare the code to execute a command or query of an application represented by the user input against the application object models. Thus, there are two aspects to the semantic objects, the descriptor, such as an XML descriptor, which describes an utterance, and the code which acts upon that descriptor. The present invention provides a unification between the descriptor and the code utilizing the attributes which are available in a shared runtime environment such as CLR. In such an embodiment, the developer can introduce custom object types and attributes which are built into the structured metadata of the object types and which are compiled with the object code. Standardized APIs are used to access the metadata. The attributes define the behavior of the objects. This allows the developer to author objects by both defining the objects, and specifying their behavior in a single place, and thus synchronization between the object definition and their behavior is maintained. These objects can also be introduced without inhibiting the interoperability of the runtime platform.

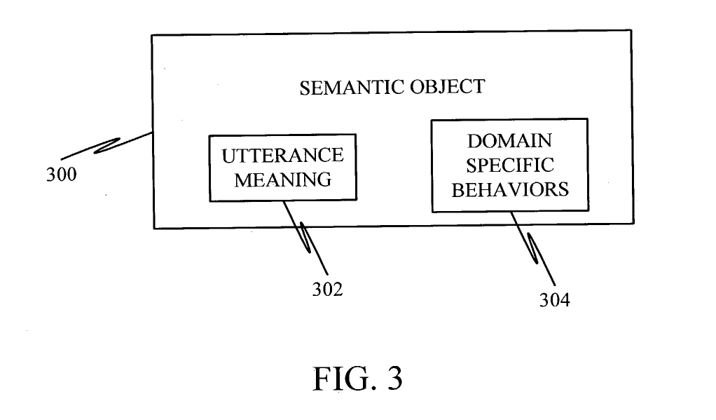

FIG. 3 is a block diagram of an example semantic object 300 for use in semantic layer 200. The semantic object 300 includes a representation of the meaning of the user's utterance 302 and a representation which encapsulates domain specific behaviors 304 of the utterance 302. The semantic object 300 provides one way of referring to a domain entity. A specific domain entity can be identified by any number of different semantic objects with each one representing the same domain entity phrased in different ways. The term semantic polymorphism can be used to mean that a specific entity may be identified by multiple semantic objects. The richness of the semantic objects, that is the number of semantic objects, their interrelationships and their complexity, corresponds to the level of user expressiveness that an application would enable in its natural language interface. As an example of polymorphism “John Doe”, “VP of NISD”, and “Jim's manager” all refer to the same person (John Doe) and are captured by the different semantic objects PersonByName, PersonByJob, and PersonByRelationship, respectively.

As discussed below, semantic objects can be nested and interrelated to one another including recursive interrelations. In other words, a semantic object may have constituents that are themselves semantic objects. For example, “Jim's manager” corresponds to a semantic object having two constituents: “Jim” which is a “Person” semantic object and “Jim's Manager” which is a “PersonByRelationship” semantic object.

The semantic object definition of the present invention provides a link to the domain behaviors. In order to initiate the desired domain behaviors, the semantic objects are evaluated against the application domain. For example, if the semantic object is related to sending mail to a particular recipient, the recipient must be ascertained and the command to send mail must be executed. In authoring an application, the application developer typically writes customized codes to initiate the specific domain behaviors. However, in the authoring framework of the present invention, the declaration of the semantic object and implementation of its domain behavior are combined into a single step by annotating objects in the authoring language by using the appropriate attributes of the language. Because the annotations in the attributes are compiled into code at runtime, both the definition of the semantic objects and their behavior are authored in the same step. These semantic objects can then be implemented in a virtual machine or other runtime environment.

In a specific example, the semantic objects are implemented in Common Language Runtime (CLR) by annotating CLR objects to implement domain behaviors with CLR attributes. This configuration provides a common virtual runtime across multiple languages and platforms.

The following example defines three semantic objects. In the example, all semantic objects are a subclass of the class SemObject and inherit this base class.

[SemType(typeof(string), friendlyName=”Command”)]
public class SendMail : SemObject
{

public object[] SemResult {

get { ... }
...

}
[SemType (typeof(IPerson),friendlyName=“Person”)

]

public SemObject Recipient;
...

}
[SemType(typeof(IPerson),friendlyName=”Person”)]
public class PersonByName : SemObject
{

...
[SemType(typeof(string))]
public string FirstName;
[SemType(typeof(string))]
public string LastName;
public object[] SemResult {

get {

// search database using firstname

lastname

}
...

}

}
[SemType(typeof(IPerson),friendlyName=”Person”)]
public class PersonByRelationship : SemObject
{

...
[SemType(typeof(IPerson),friendlyName=”Person”)

]

public SemObject Reference;
[SemType(typeof(string))]
public string Relation;
public object[] SemResult {

get {

// search database using Reference's

Relation

}
...

}

}

### EXAMPLE 1

In Example 1, the first semantic object defines SendMail which inherits from the base class SemObject. In other words, the semantic object and its constituents are declared as a subclass of the SemObject. The [SemType] attribute is used to declare the entity type modeled by the semantic object. As illustrated, a constituent of a semantic object can be either a semantic object itself, or simply a defined data type such as data defined by a Common Type System. The semantic type object provides a logical inference capability such that many objects of the person type can all represent the same person even though the realization mechanism is different. The semantic type provides an abstraction for reasoning without consideration of the actual resolution mechanism. With the semantic objects of the present invention, the data field declares various semantic slots. The attributes allow recursive calls into an arbitrarily deep structure. Further, the semantic objects of the present invention can give the underlying platform which implements the natural language interface various cues as to the actual linguistic structure or grammar. As one example, the semantic objects can be used for the automatic generation of template grammar for use in recognizing an utterance.

The semantic objects are annotated to provide domain specific behavior. The SemObject base class mandates the implementation of a SemResult property. The property, although declared with an ‘object’ type, should correspond to the domain entity which the semantic object describes. In Example 1, SendMail semantic object has a constituent semantic object which represents the recipient of the email. The mail recipient is represented using IPerson. Note that Example 1 uses the IPerson data source property. This is defined in accordance with the Collaboration Data Objects (CDO) IPerson interface which provides an IDataSource interface connected to a contact. The IPerson interface provides numerous properties including company information, email addresses, names, cities, phone numbers, etc. This particular interface is provided for example purposes only and the present invention is not limited to this example.

IPerson is further defined by two semantic objects, PersonByName and PersonByRelatiohship which will both return a result of IPerson through their SemResult property. The returned result of type IPerson can then be filled into the Recipient slot of the SendMail semantic property.

The SemResult thus initiates a particular domain behavior for the semantic object. In Example 1, for the semantic object PersonByName, a domain behavior is initiated which searches a database using the FirstName and LastName strings which identify the person. When the person is identified through the PersonByRelationship semantic object, the domain behavior annotation performs a database search using the References relation. Note that the third semantic object is configured to operate recursively so that it can be filled with another PersonByRelationship or a PersonByName using the type IPerson. The semantic object SendMail thus declares the semantic object type and, through its annotations, implements domain behavior to send mail to the semantic object Recipient.

It can be seen that the attributes of the semantic object framework illustrated in Example 1 describe a parent-child hierarchial tree structure of semantic objects which allows recursive object calls. This hierarchy can be referred to as a semantic schema. As source files are compiled, the semantic schema is stored in a manifest of the run time assembly. The semantic schema can be used to validate an instance of the semantic object tree.

As discussed above with respect to FIG. 2, during run time, the semantic objects in a natural language input must be identified and captured for placement into the slots defined by the SemObject. In one specific example, SAPI 5.2 is used to identify semantic objects in natural language speech inputs. The semantic objects are then serialized, for example, into a special XML format referred to as Semantic XML (SML). For example, SAPI can return the following for the utterance “Send mail to John”:

<sml text=”send mail to John” confidence=“90”>

<SendMail text=”send mail”>

<Recipient type=”Person” name=”PersonByName”

text=”John Doe”>

<FirstName type=”string”>John

</FirstName>
</Recipient>

</SendMail>

</sml>

### EXAMPLE 2

In Example 2, the entire meaning of the sentence is captured by the “SendMail” semantic object. The semantic object has one constituent semantic object which represents the recipient of the email. Every semantic object in Example 1 is represented by a corresponding XML element object in Example 2. It is the responsibility of the grammar developer to ensure that the SML conforms to the semantic schema in the run time assembly manifest.

In Example 2, the SendMail text corresponds to the top level semantic object set forth in Example 1. The top level semantic object in Example 1 has one slot, Recipient, which is populated from the utterance through the XML object. By identifying the Recipient type as PersonByName, the XML shown in Example 2 instantiates the second semantic object set forth in Example 1 to fill the type IPerson using the slots FirstName and LastName. Since the utterance only provided FirstName, and a recursion through the semantic object hierarchial tree does not fill the string LastName, the domain behavior can perform a database query to determine if this alone provides a unique identification of Recipient. If not, the discourse grammar 216 shown in FIG. 2 can be used to further query the user for the LastName string or other information to provide a unique recipient.

Context Free Grammar (CFG) learning tools can be used to ensure that the SML conforms to the semantic schema set forth in the runtime assembly manifest. Although XML is shown in Example 2, any appropriate descriptor can be used. However, XML (SML) allows for easy interchange of documents by describing their logical structure. This can be particularly advantageous where the natural language input takes place in a remote server of a distributed computing environment.

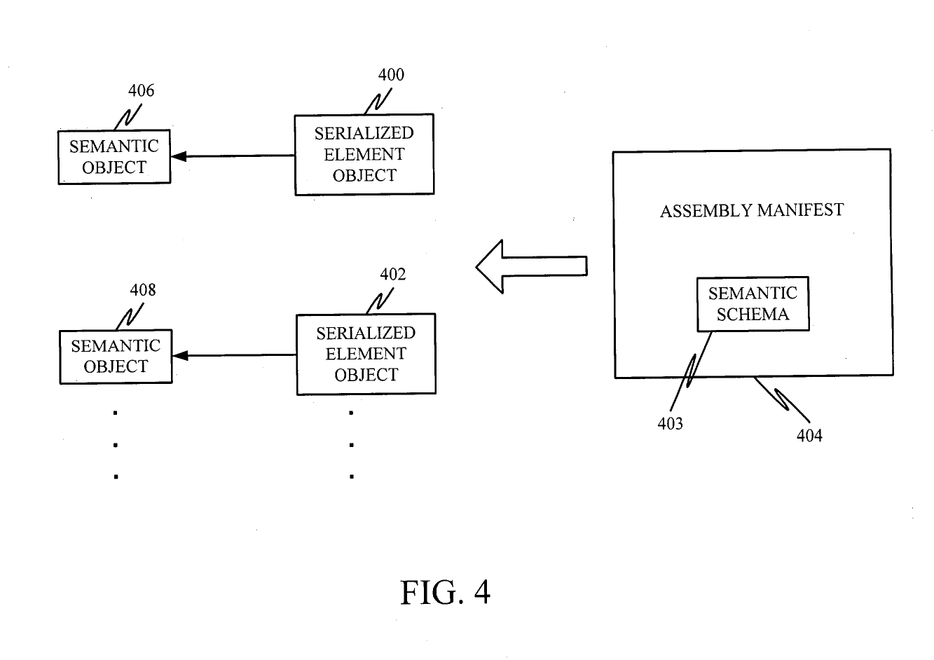

The process of deserializing the XML from Example 2 into the semantic objects of Example 1 is direct because each XML element of SML corresponds directly to a semantic object. This is insured by the way the semantic objects are computed into the assembly manifest. The deserialization process is generally illustrated in FIG. 4. The XML elements discussed above are illustrated in FIG. 4 as serialized element objects 400 and 402. As these objects are in accordance with the semantic schema 403 of the assembly manifest 404, they can be directly deserialized into the corresponding semantic objects 406 and 408, respectively. More specifically, after SAPI recognizes the utterance set forth in Example 2, the platform will first instantiate a PersonByName semantic object to fill its FirstName slot with the string “John”. The “PersonByName” semantic object is returned into the “Recipient” slot of the “SendMail” semantic object.

These examples are highly simplified in nature and provided to illustrate operation of the present invention. They illustrate operation of the invention which can be expanded to much more complex object hierarchies. When the user expression is not trivial, a tree of semantic objects is typically needed to sufficiently capture the meaning of the utterance in a manner that can be conveyed in an appropriate form to the application object models illustrated in FIG. 2. In such a configuration, the run time platform instantiates all semantic objects in the utterance, and attempts to read the SemResult of the semantic object at the root of the hierarchial tree. The “get” accessor of the SemResult must contain code to identify the domain identity of the semantic object models. For non-terminal semantic objects in the tree (i.e., semantic objects having constituents which are objects), logic is provided to obtain the SemResults of the various constituents. For example, this can trigger a recursive SemResult call down the semantic object tree until as many slots as possible in the tree are filled.

It should be noted that dialog with the user can be utilized to resolve ambiguities. For example, in Example 1, the SendMail-SemResult will include codes to first check if the Recipient property is filled. If the property is not filled, the object will trigger a dialog action through the natural language user interface 210 shown in FIG. 2 to prompt the user for more information regarding the recipients or to otherwise complete the missing information. On the other hand, if the Recipient property is filled, the code will attempt to read Recipient-SemResult and thereby invoke the “get” property in “PersonByName”. Therefore, the code in the PersonByName.SemResult invokes a database query to search for the given FirstName string, “John”. If the result is unique, the code can be configured to directly return the result of the search. If the result of the search is not unique, the code can implement logic to initiate a dialogue with the user to choose from the results of the database search or otherwise provide responses to further queries to limit the search.

The present invention has been illustrated with respect to a WebService such that the objects are reusable. Further, when the Web Server Definition Language (WSDL) is utilized, the objects are web-callable. If desired, the objects can be cast as a descendent of the WebService base class such that the object is exposed. The WSDL can be generated using the metadata from the compilation of the application source code. The metadata provides a data file to indicate the existence and types of semantic objects and what slots each object has. Upon the occurrence of a semantic inference, the metadata can be investigated. Since the semantic object is linked to the code, and the semantic object inherits from the base class, the invocation method of the semantic object is defined and no additional hook or link is necessarily required.

If desired, however, the objects can be kept private and do not need to be exposed as a web service. In such an embodiment, the base class semantic object is a top level object and does not inherit from the WebService base class.

The invention is applicable to the semantic web in which XML is used to describe semantic schema to link the semantic object to real code. However, another example is to link through the use of Resource Definition Framework (RDF).

The present invention provides a powerful authoring tool which allows the semantic objects of an application module to be maintained against a run time manifest. This framework is well suited for implementation in object based languages. In the above examples and discussion, an architecture has been described which is well suited for implementation in a distributed computing environment such as one distributed across the a global computer network. However, the present invention can be implemented in a non-distributed environment or a computing environment having only local distribution. If the present invention is implemented in a virtual run time environment, the distribution can occur without limitation to the particular hardware or software implementations of each specific computer system. Further, such a run time environment can be implemented to operate across disparate languages, such as the CLR.

In authoring applications, the developer describes the semantic objects of the present invention. Attributes are introduced into objects to specify behavior and to thus provide semantic objects which bridge the gap between semantic objects and the application domain and provide synchronization therebetween. When the source files are compiled, a semantic schema is defined by these semantic objects and is stored in the manifest of the run time assembly. With the present invention, semantic objects themselves provide information regarding the domain to construct the semantic schema. This allows the developer to author semantic objects and their behavior in a single location.

Although the present invention has been described with reference to particular embodiments, workers skilled in the art will recognize that changes may be made in form and detail without departing from the spirit and scope of the invention.

What is claimed is:

1. A method of providing an object mode corresponding to an application with input from a natural language source, comprising:
receiving a natural language input;
identifying a semantic object represented by the natural language input, the semantic object indicative of a semantic meaning representation of the natural language input and a semantic result property corresponding to a domain entity of the semantic object; and
providing an application input to the application based upon the semantic object.

2. The method of claim 1 wherein the semantic result property instantiates a second semantic object.

3. The method of claim 1 wherein the semantic object is implemented in a virtual run time environment.

4. The method of claim 1 wherein the semantic object is implemented in a common language run time environment.

5. The method of claim 1 including generating a semantic schema based upon the semantic object.

6. The method of claim 1 wherein the semantic object provides semantic cues related to the domain entity to a natural language interface.

7. The method of claim 1 wherein the semantic object is shared across a distributed computer system.

8. The method of claim 1 wherein the semantic object includes data defined by a common type system.

9. The method of claim 1 including generating template grammar for use in recognizing an utterance as a function of the semantic object.

10. The method of claim 1 wherein the semantic object is defined in accordance with a collaborative data object interface.

11. The method of claim 1 including defining a plurality of semantic objects in a parent-child hierarchial tree structure.

12. The method of claim 11 wherein the hierarchial tree structure defines a semantic schema.

13. The method of claim 1 including compiling source code which includes the semantic object and responsively generating a shared manifest.

14. The method of claim 1 including filling slots of the semantic object using serialized data.

15. The method of claim 14 wherein the serialized data is in accordance with an XML format.

16. The method of claim 1 wherein the semantic result property initiates a command in a run time platform.

17. The method of claim 1 wherein the semantic object inherits from a WebService base class.

18. The method of claim 1 wherein the semantic object is authorable in a plurality of authoring languages.

19. An object receiving an input from a natural language interface, comprising:
a first portion corresponding to a meaning of a natural language input; and
a second portion corresponding to domain specific behavior associated with the meaning of the natural language input.

20. The invention of claim 19 including a second object instantiable by one of the first and second portions.

21. A computer-readable medium providing computer-executable instructions for providing an object module application with input from a natural language source, comprising:
receiving a natural language input;
identifying a semantic object represented by the natural language input, the semantic object indicative of a semantic meaning representation of the natural language input and a semantic result property corresponding to a domain entity of the semantic object; and
providing an application input to the application based upon the semantic object.

22. An object for receiving an input from a natural language interface, comprising:
a first portion corresponding to a meaning of a natural language utterance; and
a second portion corresponding to domain specific behavior associated with the natural language utterance.

23. A natural language processing system comprising:
a semantic object identifier receiving a natural language input and identifying a semantic object in the natural language input;
a semantic layer including semantic objects that themselves define a domain specific behavior associated with the semantic objects; and
an application object model against which the domain specific behavior is executed.

24. The natural language processing system of claim 23 wherein the semantic objects each comprising:
a first portion indicative of a semantic object type of the semantic object; and
a second portion indicative of the domain specific behavior of the semantic object.

25. The natural language processing system of claim 24 wherein the semantic object type is specified in a Common Language Runtime (CLR) language.

26. The natural language processing system of claim 25 wherein the domain specific behavior is specified in attributes of the semantic objects in CLR.

27. An object authored in common language runtime (CLR) for specifying a semantic object type represented by a natural language input, comprising:
a first portion indicative of a semantic object type; and
an attribute portion, indicative of a domain specific behavior associated with the object.
